(19) United States
(12) Patent Application Publication
(10) Pub. No.: US 2007/0046818 A1
(43) Pub. Date: Mar. 1, 2007

(54) Picture display device and picture display method

(75) Inventor: Satoshi Uchino, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/509,672

(22) Filed: Aug. 25, 2006

(30) Foreign Application Priority Data
Aug. 30, 2005 (JP) 2005-249783

(51) Int. Cl. H04N 5/46; H04N 9/74

(52) U.S. Cl. 348/556; 348/581

(57) ABSTRACT

According to one embodiment, there is provided a picture display device has a detecting unit which detects a continuous movement of an entire picture or an identical object for a predetermined time period or more in a screen provided by a given video signal, a selecting unit which selects a first image mode when the movement of the entire picture or the identical object fails to be detected, and selects a second image mode different from the first image mode when the movement is detected, a scaling unit which executes a scaling process on the video signal corresponding to the selected first image mode or second image mode, and a display unit which displays a picture corresponding to the video signal subjected to the scaling process.

### CROSS-REFERENCE TO RELATED APPLICATIONS

This application is based upon and claims the benefit of priority from Japanese Patent Application No. 2005-249783, filed Aug. 30, 2005, the entire contents of which are incorporated herein by reference.

### BACKGROUND

1. Field

One embodiment of the invention relates to a picture display device having a plurality of display modes, and more particularly, to a picture display device and picture display method for selecting a display mode when movement of an entire image on a screen or an identical object in the horizontal direction or the like is detected.

2. Description of the Related Art

In recent years, a display screen with an aspect ratio of 16:9 has been prevailing in addition to a conventional display screen with an aspect ratio of 4:3, and pictures of the both display screens have been often displayed on the display screen with the aspect ratio of 16:9.

When a picture with an aspect ratio of 4:3 is displayed on a display screen with an aspect ratio of 16:9, the aspect ratio near its center is approximately 1:1, and the picture can be displayed on an entire screen by raising an elongation ratio in the horizontal direction as it goes to the right and left ends.

Patent document 1 (Jpn. Pat. Appln. KOKAI Publication No. 2003-189266) has disclosed the above-described display method.

However, if an identical object (for example, the face of a person or a vehicle) moves from the right or left end to the central portion of a screen in the patent document 1, the state in which its size is contracting when the face or vehicle moves from the right or left end to the central portion is very noticeable, thereby providing a viewer with a feeling of disharmony, which is a problem to be solved.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an example of a configuration of a picture display device according to an embodiment of the present invention;

FIG. 2 is a block diagram showing another example of the configuration of the picture display device according to the embodiment of the present invention;

FIG. 3 is an explanatory view showing an example of a display on the picture display device according to the embodiment of the present invention;

FIG. 4 is an explanatory view showing an example of changes of the display on the picture display device according to the embodiment of the present invention;

FIG. 5 is an explanatory view showing another example of changes of the display on the picture display device according to the embodiment of the present invention;

FIG. 6 is an explanatory view showing an example of a table of display modes of the picture display device according to the embodiment of the present invention;

FIG. 7 is a flow chart showing creation of a table of display modes of the picture display device according to the embodiment of the present invention; and

FIG. 8 is a flow chart showing an example of a display processing corresponding to a display mode of the picture display device according to the embodiment of the present invention.

### DETAILED DESCRIPTION

Various embodiments according to the invention will be described hereinafter with reference to the accompanying drawings. In general, according to one embodiment of the invention, there is provided a picture display device and picture display method capable of displaying a picture without a feeling of disharmony even if an entire picture of a screen or an identical object moves in the screen when a picture having an aspect ratio different from an aspect ratio of the screen is displayed.

A picture display device according to one embodiment of the present invention comprises a detecting unit, a selecting unit, a scaling unit, and a display unit. The detecting unit detects a continuous movement of an entire picture or an identical object for a predetermined time period or more in a screen produced by a given video signal. The selecting unit selects a first image mode when the detecting unit fails to detect the continuous movement of the entire picture or the identical object for a predetermined time period or more, and selects a second image mode different from the first image mode when the detecting unit detects the continuous movement of the entire picture or the identical object for a predetermined time period or more. The scaling unit executes a scaling process on the video signal. The display unit displays a picture on the screen corresponding to the video signal subjected to the scaling process.

The present invention enables to display a picture without a feeling of disharmony even if an entire picture or an identical object moves in the screen when a picture having an aspect ratio different from the aspect ratio of the screen is displayed.

Hereinafter, the embodiments of the present invention will be described in detail with reference to the drawings.

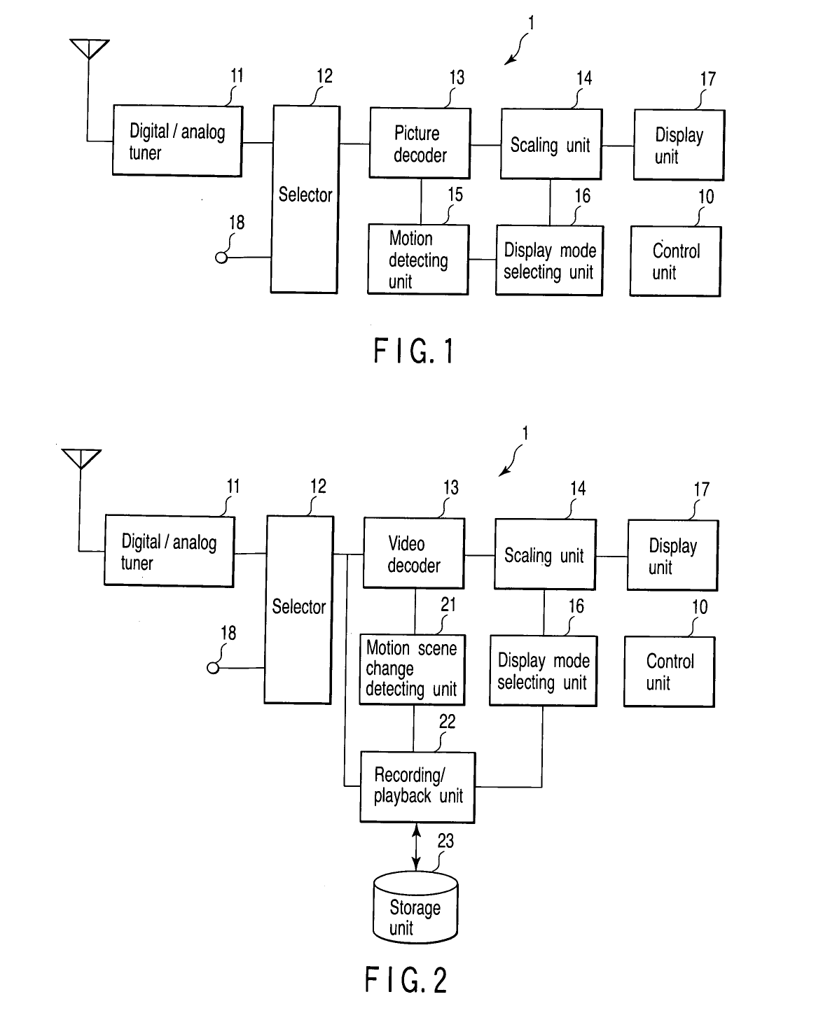

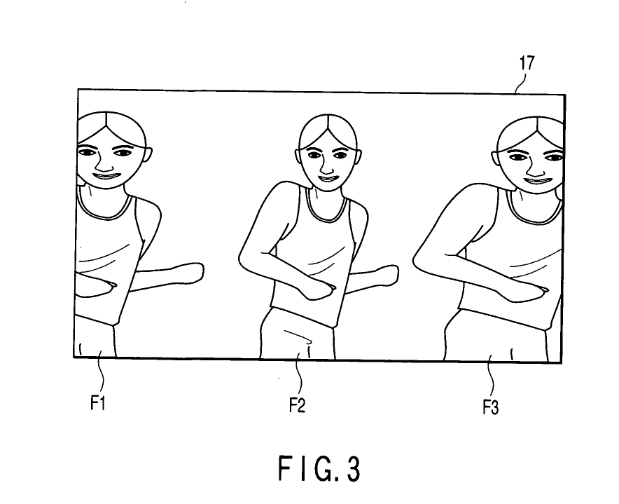

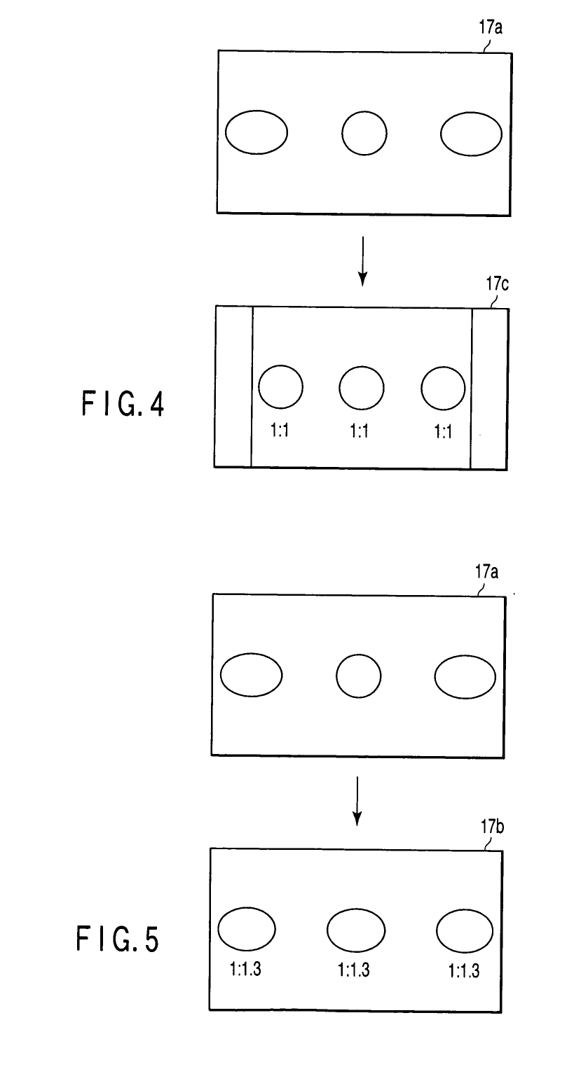

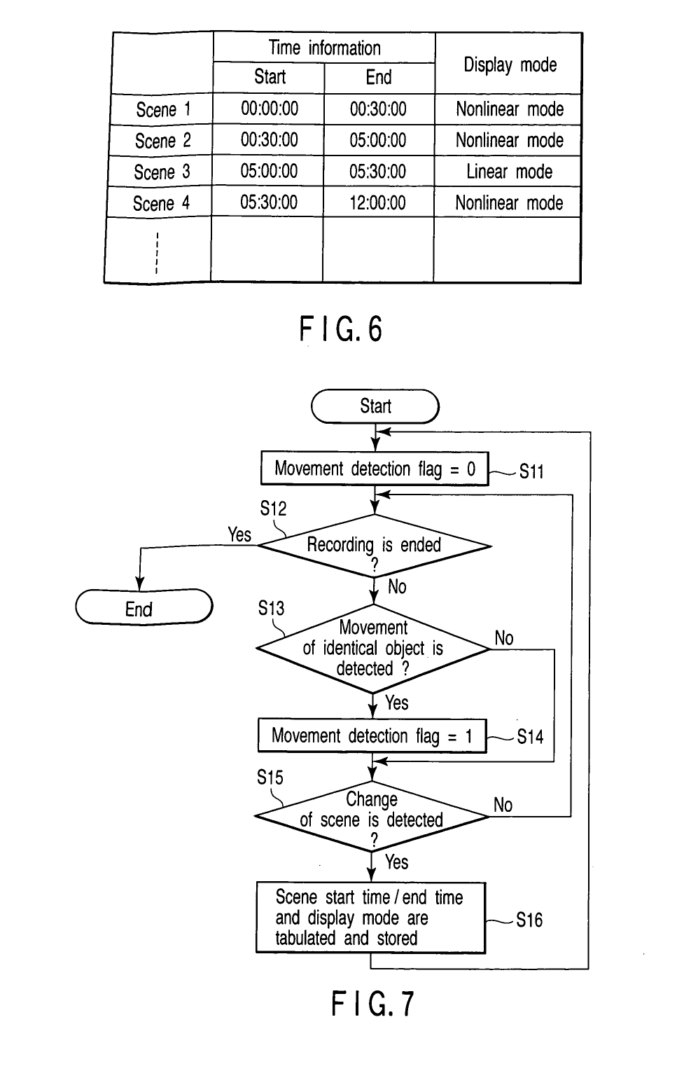

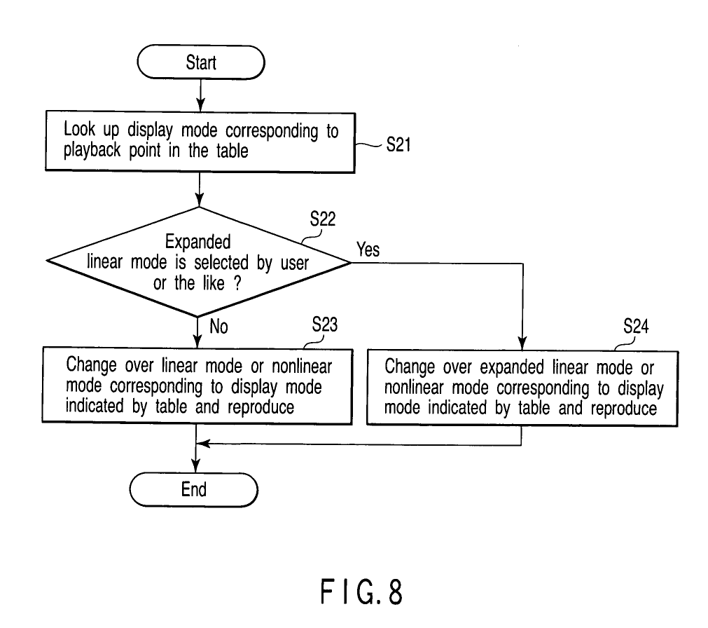

FIG. 1 is a block diagram showing an example of a configuration of a picture display device according to an embodiment of the present invention. FIG. 2 is a block diagram showing another example of the configuration of the picture display device. FIG. 3 is an explanatory view showing an example of a display on the picture display device. FIG. 4 is an explanatory view showing an example of changes of the display on the picture display device. FIG. 5 is an explanatory view showing another example of changes of the display on the picture display device. FIG. 6 is an explanatory view showing an example of a table of display modes of the picture display device. FIG. 7 is a flow chart showing creation of a table of display modes of the picture display device. FIG. 8 is a flow chart showing an example of a display processing corresponding to the display mode of the picture display device.

<Picture Display Device of the Present Invention>

(Configuration)

FIG. 1 shows an example of the picture display device of the invention. The picture display device 1 comprises a digital/analog tuner unit 11 connected to an antenna, a selector 12, a video decoder 13, a scaling unit 14, a motion detecting unit 15, a display mode selecting unit 16, a display unit 17, and a control unit 10. The digital/analog tuner unit 11 and an external terminal 18 are connected to the selector 12. The video decoder 13 receives a signal from the selector 12. The scaling unit 14 receives a signal from the video decoder 13 to execute a scaling process. The motion detecting unit 15 receives an output from the video decoder 13 to detect a movement of an entire picture or an identical object. The display mode selecting unit 16 determines a display mode by receiving a detection signal of the motion detecting unit 15, and supplies a result of the determination to the scaling unit 14. The display unit 17 receives an output of the scaling unit 14 to display a picture. The control unit 10 controls the entire operation. At this time, the display unit 17 is a display having an aspect ratio of 16:9 as shown in FIG. 3, for example.

FIG. 2 shows another example of the configuration of the picture display device according to the invention. The picture display device 1 comprises a digital/analog tuner unit 11 connected to an antenna, a selector 12, a video decoder 13, a scaling unit 14, a detecting unit 21, a display mode selecting unit 16, an Recording/playback 22, a storage unit 23, a display unit 17, and a control unit 10. The digital/analog tuner unit 11 and an external terminal 18 are connected to the selector 12. The video decoder 13 receives a signal from the selector 12. The scaling unit 14 receives a signal from the video decoder 13 to execute a scaling process. The detecting unit 21 identifies a scene area by receiving an output from the video decoder 13, and detects a movement of an entire picture or an identical object of each scene. The display mode selecting unit 16 determines a display mode by receiving an output of the Recording/playback 22, and supplies a result of the determination to the scaling unit 14. The Recording/playback 22 receives a video signal from the motion scene change detecting unit 21 to accumulate and reproduce the video signal. The storage unit 23 stores the video signal from the selector 12 in a storage area. The display unit 17 receives an output of the scaling unit 14 to display a picture. The control unit 10 controls the entire operation.

(Faults of Display)

Next, the display characteristics of the picture display device 1 are considered as follows. The display unit 17 of the picture display device 1 has an aspect ratio of 16:9 as described above, and can display a picture without a feeling of disharmony when for example, the tuner unit 11 receives a broadcasting signal of 16:9. However, the broadcasting signal or the video signal supplied from the external terminal 18 often has the conventional aspect ratio of 4:3 as well as the aspect ratio of 16:9.

In case where the aspect ratio of the given video signal is 4:3 and the aspect ratio of the display unit 17 is 16:9, the scaling unit 14 performs the scaling process to display a picture meeting the display unit 17. More specifically, an MPEG video signal with, for example, an aspect ratio of 4:3 supplied from the digital/analog tuner unit 11 is decoded by the video decoder 13. Thereafter, in accordance with a nonlinear mode as shown in FIG. 4, the scaling unit 14 executes the scaling process on the video signal by expanding pictures on the right and left ends of the screen in the right/left direction and bringing the elongation ratio close to 1 gradually as it goes near the central portion of the screen while the picture in the central portion of the screen does not need to be expanded. Consequently, a picture with an aspect ratio of 4:3 can be displayed on a screen with an aspect ratio of 16:9. Because the central portion of the screen is not so expanded horizontally, distortion of the picture on the periphery tends to be intensified while the display in the central portion is relatively natural.

Thus, when, even if the scaling process is carried out stepwise, part of a picture moves at a specified speed in the horizontal direction, for example, a marathon runner passes over a fixed camera, his face and body, which must be displayed in the same size, look as if they change as his body moves in the screen, whereby providing a viewer with a feeling of disharmony. The present invention intends to eliminate such a fault by changing non-linear elongation process to linear elongation process.

(Operation)

Hereinafter, the elongation process of the picture display device of the present invention will be described in detail with reference to the drawings and flow charts. The picture display device of the invention operates as follows by way of example. That is, when the motion detecting unit 15 detects a movement of an entire picture or an identical object, two display modes, that is, linear elongation process and non-linear elongation process are changed over by the scaling unit 14, so that the above-described change of the entire picture or the identical object is eliminated.

Real-Time Change-Over

First, description will be given to an embodiment in which, with the configuration shown in FIG. 1, a movement of an entire picture or identical object is detected by the motion detecting unit 15 corresponding to a given video signal and the display mode is changed over correspondingly.

A video signal from the digital/analog tuner 1 is received under the control of the control unit 10, and the motion detecting unit 15 detects whether or not a motion vector of a substantially specified direction (for example, horizontal movement) and size is detected continuously for a predetermined time period in an entire picture or an identical object from, for example, an MPEG2-encoded video signal in the screen. This means a case where the identical object moves horizontally as shown in FIG. 3. Here, a case where the object just stays in the central portion of the screen, or a case where no motion vector of the substantially specified direction and size is detected continuously for a predetermined time period because the object stays on the side portion of the screen does not fall under this case, and no noticeable change of the elongation ratio is found on the screen.

If the movement of the entire picture or the identical object exists, the display mode selecting unit 16 changes the display mode from the non-linear mode to the linear mode, and unless such move exists, the display mode is set to the non-linear mode. The selected display mode is supplied to the scaling unit 14, and the scaling unit 14 executes a scaling process on the video signal to reproduces it.

Consequently, as shown in FIG. 4, the non-linear mode screen 17a changes to the linear mode screen 17c. As a result, even if the entire picture or the identical object moves from the side portion of the screen to the central portion, the elongation ratio never changes, so that a viewer does not feel a disharmony.

Change-Over of the Scene

Next, with reference to the flow charts of FIGS. 7 and 8, detailed description will be given to an embodiment in which a video signal is divided to plural scene areas with the configuration using the Recording/playback 22 and the storage unit 23 shown in FIG. 2, and a display mode is determined for each scene area to create a table and change over the display mode.

Since the following flowchart can be made of circuit blocks, each step of the flowchart can be defined as a block.

First, tabulation of the display mode for each scene will be described. Assume that a movement detection flag is 0 under the control of the control unit 10 (step S11). Then, a video signal from the digital/analog tuner 11 or a video signal from the external terminal 18 is stored in the storage unit 23 under the control of the Recording/playback 22 (step S12). While recording, the motion detecting unit 15 detects whether or not a motion vector of substantially specified direction (for example, horizontal movement) and size is detected continuously in an entire picture or an identical object for a predetermined time period from, for example, an MPEG2-encoded video signal intended to be recorded, in a scene. This means that the identical object moves in the horizontal direction as shown in FIG. 3. Here, a case where the object just stays in the central portion of the screen, or a case where no motion vector of the substantially specified direction and size is detected continuously for a predetermined time period because the object stays on the side portion of the screen does not fall under this case, and no noticeable change of the elongation ratio is found on the screen.

If the above-mentioned movement of the entire picture or the identical object exists (step S13), the movement detection flag is set to 1 (step S14) and the display mode is changed from non-linear mode to linear mode by the display mode selecting unit 16. Unless such move exists, the display mode is set to the non-linear mode.

If the head of a scene is detected by comparing frames with each other (step S15), the display mode corresponding to whether or not the movement of the entire picture or the identical object exists in data of each scene is stored as a table shown in FIG. 6 (step S16). The table shown in FIG. 6 indicates a start time and end time of each scene and the display mode of this scene. A table of each scene for the display mode is created by cutting out such a scene area and adding table information. This operation is continued until the recording process for the video signal is ended.

The video signal recorded in this way possesses the above-described table for each scene. Look up the display mode corresponding to playback point in the table (S21).

In this embodiment, at least a normal linear mode shown in FIG. 4 and an expanded linear mode shown in FIG. 5 are indicated as the linear mode.

FIG. 4 shows the normal linear mode, which shows a case where the nonlinear mode display screen 17a is changed to the linear mode display screen 17c. In this case, a viewer feels no disharmony in the linear mode display screen 17c because the elongation ratio does not change even if the entire picture or the identical object moves from the side portion of the screen to the central portion.

The expanded linear mode is the display mode indicated in FIG. 5, which applies a picture of 4:3 to a screen of 16:9 with linearity by expanding pictures uniformly at a ratio of 1:1.3 horizontally when the nonlinear mode display screen 17a is changed to the expanded linear mode display screen 17b. Consequently, even if the entire picture or the identical object moves from the side portion to the central portion in the horizontal direction, the elongation ratio is not changed, and therefore, the viewer does feel a disharmony.

It is preferable that the user arbitrarily selects the normal linear mode or the expanded linear mode, or that one of them is set on default preliminarily.

Unless the expanded linear mode is specified (step S22), the display mode selecting unit 16 changes over the linear mode or the nonlinear mode depending on a display mode indicated by the table, and the video signal is subjected to a scaling process by the scaling unit 14 to be reproduced (step S23).

If the expanded linear mode is specified (step S22), the display mode selecting unit 16 changes over the expanded linear mode or the nonlinear mode depending on a display mode indicated by the table, and the video signal is subjected to a scaling process by the scaling unit 14 to be reproduced (step S24).

In the meantime, it is preferable that the process of changing over the linear mode and the nonlinear mode according to the embodiment can be selected by the user arbitrarily on a setting screen, and a specified display mode (nonlinear mode, linear mode, expanded linear mode or the like) is applied fixedly by the user's setting the change-over processing to OFF.

Those skilled in the art can achieve the present invention through the various embodiments described above, and those skilled in the art also can image various modifications of these embodiments easily, so that they can apply the present invention to a variety of embodiments even if they are lack of inventive ability. Therefore, the present invention covers a wide range not inconsistent with the disclosed principles and novel features, and is not restricted to the above-described embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A picture display device comprising:
a detecting unit which detects a continuous movement of an entire picture or an identical object for a predetermined time period or more in a screen provided by a given video signal;
a selecting unit which selects a first image mode when the detecting unit fails to detect the continuous movement of the entire picture or the identical object for a predetermined time period or more, and selects a second image mode different from the first image mode when the detecting unit detects the continuous movement of the entire picture or the identical object for a predetermined time period or more;
a scaling unit which executes a scaling process on the video signal corresponding to the first image mode or the second image mode selected by the selecting unit; and
a display unit which displays a picture corresponding to the video signal subjected to the scaling process by the scaling unit.

2. The picture display device according to claim 1, further comprising:
an extracting unit which extracts a plurality of scene areas from the video signal, wherein
the detecting unit and the selecting unit detect the continuous movement of the entire picture or the identical object for a predetermined time period or more for each of the scene areas, and selects the first image mode or the second image mode corresponding to the detection.

3. The picture display according to claim 1, wherein the first image mode executes a scaling process with an aspect ratio of 1:1 in the vicinity of the central portion of the screen while an elongation ratio in the horizontal direction is increased as it goes to the right and left ends, and
the second image mode executes a scaling process with an aspect ratio of 1:1 in the entire screen.

4. The picture display according to claim 1, wherein the first image mode executes a scaling process with an aspect ratio of 1:1 in the vicinity of the central portion of the screen while an elongation ratio in the horizontal direction is increased as it goes to the right and left ends, and
the second image mode executes a scaling process with an aspect ratio of higher than 1:1 in the entire screen.

5. The picture display device according to claim 1, further comprising:
a tuner unit which supplies the video signal to the detecting unit by tuning and demodulating a broadcast signal.

6. A picture display method comprising:
detecting a continuous movement of an entire picture or an identical object for a predetermined time period or more in a screen provided by a given video signal;
selecting a first image mode when the continuous movement of the entire picture or the identical object for a predetermined time period or more is fails to be detected, and selecting a second image mode different from the first image mode when the continuous movement of the entire picture or the identical object for a predetermined time period or more is detected;
executing a scaling process on the video signal corresponding to the selected first image mode or second image mode; and
displaying a picture corresponding to the video signal subjected to the scaling process on a screen.
